(19) United States
(12) Patent Application Publication
(10) Pub. No.: US 2015/0240777 A1
(43) Pub. Date: Aug. 27, 2015

(54) Turbine structure and OWC device comprising such turbine structure

(71) Applicants: Alessandro NARDELLI, Messina (IT); Francesco LA SPADA, Lipari (ME) (IT)

(72) Inventors: Alessandro Nardelli, Messina (IT); Francesco La Spada, Lipari (ME) (IT)

(21) Appl. No.: 14/432,419

(22) PCT Filed: Oct. 4, 2013
(86) PCT No.: PCT/IB2013/059108

§ 371 Date: Mar. 30, 2015

(30) Foreign Application Priority Data
Oct. 5, 2012 (IT) ME2012A000012

(51) Int. Cl. F03B 3/18; F03B 3/04; F03B 11/00; F03B 13/22; F03B 13/14

(52) U.S. Cl. CPC F03B 3/18; F03B 13/22; F03B 13/142; F03B 11/006; F03B 3/04

(57) ABSTRACT

A turbine structure, includes a rotor having a hub rotatable about a central axis of rotation and adapted to be operatively coupled to an external system generating electric power, a plurality of laminar elements firmly associated with the hub and arranged peripherally of the central axis of rotation to intercept a fluid stream, wherein each laminar element includes a flexible seal having upper and lower opposite faces adapted to alternatively engage the fluid stream to deform and transmit a driving torque to the rotor. The seals radially extend outwardly from the outer peripheral wall of the hub with respective opposite faces extending, in a non-deformed condition, mainly in planes substantially coplanar with each other and to the plane of the hub, perpendicular to the axis of rotation, to define as a whole respective mutually opposite surfaces adapted to be alternately invested by the fluid stream on their entire extension.

### TECHNICAL FIELD

The present invention deals with the technical field of the device for energy conversion and more particularly relates with a turbine structure adapted to be preferably used in side OWC device (Oscillating Water Column). The invention also relates with a OWC device comprising the turbine structure.

### STATE OF THE ART

Several types of devices, generally referred as WECs (Wave Energy Converters), are known, which devices being adapted to generate electrical power starting from the conversion of the energy associated to wave motion, namely to the motion of the water at the level of the sea surface.

In particular, the more common types are the overflowing devices, the articulated rafts, buoys and floats, controlled floating devices, OWC devices (Oscillating Water Columns).

In particular, the latter represent a particularly efficient type of device whose principle of operation is somewhat similar to that of the wind turbines, because they use air turbines to produce energy.

Generally, the known OWC devices consist of a containment structure having an inner chamber partially submerged and in communication with the surrounding sea environment through an opening on the bottom, located below the water level. By this way, the wave is captured within the structure causing the formation of a water column that holds a predetermined air volume in the space above.

The above air volume varies periodically, increasing and decreasing, depending on the compression/decompression movements exercised by the waves coming in and out of the structure.

The resulting effect is that the air is forced in both directions through the vanes of a turbine housed inside the chamber and that in most cases rotates in only one sense, regardless of the direction of the flow (eg. Wells turbine).

The mechanical movement of the turbine drives a motor connected to the main axis of the rotor of the same turbine so as to generate the electric current.

Since the mid-eighties OWC units prototypes were placed in function at several sites in the world and the designers have developed for this technology a knowledge greater than any other one.

Currently, many systems have been developed for energy conversion from the wave motion and there are various inventions relating to turbines, connected to a power generator, which exploit the alternate air flow in OWC plants, overcoming the drawback due to the need to allow turbines always turn in the same sense, regardless of the continuous reversal of direction of the fluid flow in such plants.

The turbines currently used in the OWC system are of two types: the ones which use rotors provided with fixed rigid vanes and the ones that by contrast use rigid vanes with variable inclination on the rotor, as disclosed for example in the patent application EP1904689 in name of Oceanlinx.

The rigid vanes turbine are further divided into turbine having a rotor that rotates in the same sense for any incident direction of the fluid, for example Wells turbines, Voith and the like, and those which require a preliminary deviation of the incident flow, for example modified Pelton turbines and the like.

The main drawback of these devices is that they need to use, to overcome their inherent problems, complex mechanical equipment to ensure their working.

More specifically the Wells turbines, as known, have the drawback of not being able to self-start the rotation and therefore their activation is carried out via additional motors. The unidirectional turbines require a complex system of valves to convert the alternate air flow in order to get to the turbine from a single direction.

The variable vanes turbine, instead, require mechanical, electromechanical, hydraulic or pneumatic systems, that allow the vanes to rotate on their axis, to allow the rotor to rotate always in the same sense regardless of the alternation of the air flow direction. Therefore, all these solutions have the drawback of requiring specific equipment that make possible its operation and that, other than representing a disadvantage due to higher costs for construction and installation, are realized by extremely complex mechanical devices, ill-adapted to an use in critical environments such as in the sea, with significant durability problems and, above all, with expensive and frequent maintenance.

In the field of devices for the converting energy associated with fluid streams into electrical power some types of turbines are also known which are suitable for converting the energy associated with a wave into electrical power, although not specifically designed for such purposes, which have a rotor in which the rigid vanes are replaced by sail-like flexible bodies, such as those disclosed in US2009/236858 and in DE 102008059651.

Firstly, these turbines are all of the vertical axis type and are not suitable for being placed in OWC devices; moreover, despite having a rotor adapted to always turn in the same sense, even after the reversal of the sense of the fluid flow, as well as any rotor for wind turbines with vertical axis, they are limited by the fact that only a part of the sails fully converts the thrust action exerted by the flow, i.e. those exposed toward the side of origin of the fluid, while, during the rotation, another part of them should be not operative, not contributing to the thrust action.

### SCOPE OF THE INVENTION

An object of the present invention is to at least partly overcome the above drawbacks of the state of the art, providing a turbine structure, particularly but not exclusively adapted for OWC devices, which is particularly efficient and relatively cost-effective.

A particular object is to realize a turbine structure, particularly for OWC devices, which can rotate always in the same sense, automatically adapting itself to the flow reversion of the working fluid, without any type of control equipment.

Still another object is to provide a turbine structure, particularly for OWC devices, which is simple to realize, without complex control mechanisms, so resulting economical and reliable, even in particularly hostile environments such as sea, and with reduced costs for installation and maintenance.

Still another object is to provide a turbine structure, particularly for OWC devices, that is both effective and economic even with low or moderate wave motion.

Not last object of the present invention is to provide a OWC device simple and effective to be realized and which allows to convert the energy associated to a wave motion into electrical power with relatively high yields.

These and other objects, which will appear more clear hereinafter, are achieved by a turbine structure, particularly for OWC devices, which, according to claim 1, comprises a rotor having a hub rotatable about a central axis of rotation operatively coupled to external means for the electric power generation, a plurality of laminar elements firmly associated to said hub and placed peripherally to said central axis of rotation to intercept a fluid stream and produce the rotation of said hub with a predetermined sense, wherein each of said laminar elements comprises a flexible sail having opposite faces adapted to interact alternately with the fluid stream to deform and transmit a driving torque to said rotor.

The turbine structure is characterized in that said sails radially extend outwardly from the outer peripheral wall of said hub with respective mutually opposing faces that develop, in non-deformed condition, mainly in planes substantially coplanar with each other, parallel to the plane of rotation of said hub and perpendicular to said axis of rotation.

Thus, the whole of the opposing faces of all the sails define together with each other respective peripheral surfaces adapted to be alternately invested by the fluid stream throughout their whole extension.

Thanks to this combination of features, the rotor will always receive the highest torque possible both when the fluid stream acts on the lower faces of the sails and when it acts on the upper faces, following its oscillation, due for example to the typical oscillation of the wave motion if the turbine structure is installed inside an OWC device, since the sails will be invested by the stream always for their entire surface extension, without any portion of the sails not contributing to power transmission.

Furthermore, the peculiar embodiment of the rotor having sails arranged to form a substantially circular annulus perpendicular to the central axis of rotation, peripherally thereto, will ensure that the rotor is adapted to operate with streams substantially parallel to its axis of rotation, unlike the turbine of known type which operate with stream orthogonal to their axis of rotation.

This configuration will also have the additional advantage of generating a torque sufficient to the self-starting of the turbine also in case of low impact energy of the fluid stream.

Suitably, said hub of said rotor may be substantially disc-shaped or cylindrical and may present a plurality of support shafts radially projecting outwards, each of said laminar elements having side edges fixed to corresponding consecutive shafts of said plurality. Each of said support shafts may be associated with adjacent side edges of two distinct and successive laminar elements of said plurality, or, alternatively, the adjacent laminar elements of said plurality may have respective lateral edges facing with each other and in offset relationship with each other with a predetermined distance, said offset lateral edges being associated with distinct support shafts of said plurality.

In both cases, the turbine structure will be constructively simple and does not require special mechanisms for its actuation.

Moreover, said sails may present respective inner and/or outer front edges, which may be either substantially straight or curved with curvature also different, having a predetermined length substantially equal to each other and greater than the perimeter distance between the support shafts of the corresponding pair.

Thus, the sails will present a wider extension in order to facilitate the starting of the rotor.

Preferably, each of said laminar elements may present a corresponding sail provided with one or more openings adapted to allow the partial passage of the fluid stream through the face invested thereby.

Thus, the flow of the fluid stream through the openings on each sail will cause a depression in the portion of the rotor placed rear with respect to the flow direction, reducing the opposition to the rotation of the subsequent sail, improving the performance of the turbine.

Suitably, for each of said laminar elements, said one or more openings may be realized on a side portion of said sails and arranged on the same in such a position to produce a resulting force adapted to transmit a partial driving torque to said hub having always the same sense either when the fluid stream acts on one of said opposing faces or when acts on the other of said opposite faces.

Furthermore, said laminar elements may be provided with respective one or more openings made in the corresponding of said sails in such positions as to produce respective actuating forces substantially parallel with each other.

This particular embodiment will allow to obtain a driving torque having always the same sense and the same direction, and then an unidirectional rotation of the rotor. Advantageously, the sails may be in a material selected from the group comprising synthetic fibers, composite materials, also elastic, preferably adapted to be used in critical conditions such as in contact with sea water and may also be made by fibers having variable stiffness along their own extension so that each sail will be deformed as a consequence of the specific pressure exerted by the fluid stream.

According to a further aspect of the present invention a OWC device is provided for converting into electric power the energy associated with a wave motion which, according with claim 16, comprises a containment body having a inner housing chamber and a conduit adapted to introduce into said chamber an air column moved from the oscillating water column due to wave motion, and a turbine structure according to the invention housed into said chamber.

Advantageous embodiments of turbine structure are obtained according to the dependent claims.

### BRIEF DISCLOSURE OF THE DRAWINGS

Further features and advantages of the invention will appear more clearly in light of the description of two preferred but not exclusive embodiments of a turbine structure of the invention particularly adapted to OWC devices, shown as a non limiting examples with the aid of the annexed drawings, wherein:

FIG. 1 is a partial elevation view of the turbine structure of the invention showing the portion relative to the rotor;

FIG. 2 is a front view of the particular of the structure of FIG. 1;

FIG. 3 is a plan development of a portion of the rotor in a first preferred embodiment;

FIG. 4 is a plan development of the same portion of the rotor in a second preferred embodiment;

FIG. 5 is a partial front view of a particular of the rotor of FIG. 1 wherein two sails are highlighted in a sequence according to a first preferred embodiment;

FIGS. 6 and 7 are upper view of two sails in sequence in a spread condition and with a fluid stream acting from opposite direction;

FIG. 8 is a partial front view of the particular of FIG. 5 in a second preferred embodiment;

FIG. 9 is a upper view of the particular of FIG. 8.

### BEST MODES OF CARRYING OUT THE INVENTION

With reference to the annexed figures a turbine structure is shown which is designed to be used in devices for converting into electricity the energy associated to the motion of a fluid stream.

The turbine structure will be particularly suitable to be used in OWC devices, as well as in all those cases in which any oscillating water column is available, both on-shore and off-shore, which devices being provided with oscillation chambers realized both in shore stations, such as port caissons, breakwaters and the like, or in floating locations close to the coast or offshore (13-15 miles).

Generally, a OWC device for converting into electricity the energy associated to a wave motion, not shown in the figures because of the known type, essentially comprises a containment body having an inner housing chamber and a conduit adapted to receive at the inlet a water column with alternating wave motion and generate the motion of a corresponding air column within the chamber.

In turn, the turbine structure according to the present invention will be designed to be housed in the inner chamber, which may also define the stator thereof, to be connected to external means for the power generation, such as an alternator or the like, which is also not shown as being of known type.

In particular, the turbine structure, together with the alternator or equivalent generating means, will be placed in a containment body, having preferably a cylindrical shape or, for some applications, approximately conical close to the turbine rotor, which containment body will operate for conveying the alternating flow.

The turbine structure will be suitably placed at the outlet of the chamber, such as a caisson breakwater, in which the alternating fluid flow will be generated, close to an opening of the same diameter made on the ceiling of the chamber itself, proceeding, after the mounting, in order to realize the required electrical connections for the use of the generated electric power.

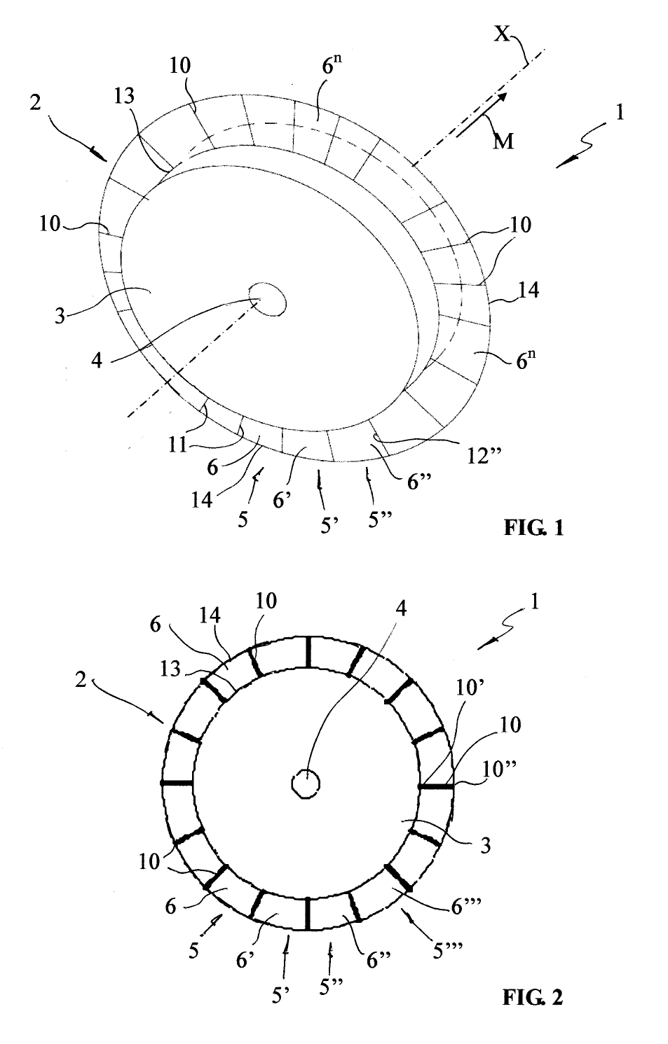

As shown in FIG. 1, the turbine structure, generally referred with 1, will comprise at least one rotor 2 having a hub 3 rotatable about a central axis of rotation X which during use can be designed to be arranged both in horizontal and vertical position, according to the specific applications.

The central axis X of the rotor 2 will also be operatively coupled to the external means for the generation of electric power, not shown because of known type and which may also coincide with the rotation shaft of an alternator belonging to the means of generation of the electric power.

By way of example, the hub 3 of the rotor 2 may present a slightly conical central hole 4 for jointing the alternator shaft.

Moreover, the rotor 2 will comprise a plurality of laminar elements 5, 5′, 5″, . . . firmly associated to the hub 3 and arranged peripherally to the central axis of rotation X to intercept a fluid stream and produce the rotation of the hub 3 with predetermined sense. The laminar elements 5, 5′, 5″, . . . of the shown embodiments will be substantially similar to each other and therefore hereinafter for the sake of simplicity will be referred, as well as the respective parts and unless otherwise indicated, with the only reference 5 without apex, minding that everything referred to the laminar element 5 will be found in a substantially similar and technically equivalent manner also in the other laminar elements 5′, 5″, . . .

Each laminar element 5 will include, preferably consist of a flexible sail 6 having opposite faces 7, 8 adapted to alternatively interact with the fluid stream for deforming itself and transmitting a driving torque M to the rotor 2.

In the present text, the terms upper and lower referred to the faces 7, 8 of the sails should be understood taking into account the most frequent positioning of the turbine structure 1 during use, which will present its central axis X in a vertical position parallel to the direction of the stream.

According to a peculiar feature of the invention, the sails 6 will radially extend outwardly from the outer peripheral wall 9 of the hub 3, being arranged therefore externally thereto, with respective upper and lower faces 7, 8 mutually opposite and extending in a not deformed condition mainly in planes substantially coplanar with each other, which will be, therefore, substantially parallel or coplanar with the plane of rotation of the hub 3, defined as the middle plane parallel to the flat faces of the hub orthogonal to the rotation axis X of the hub 3.

By this way, the upper faces 7 of the sails 6 will define an upper peripheral surface while the lower faces 8 will define a lower peripheral surface, the peripheral surfaces being adapted to be alternately invested by the fluid stream throughout their whole extension.

Consequently the faces 7, 8 of each sail 6 will be designed to be invested by the stream always for their whole surface extension.

According to the exemplary embodiment of the figures, preferred but not exclusive, the hub 3 of the rotor 2 will be substantially disc-shaped or cylindrical, or slightly tapered, and has a plurality of support shafts 10 radially projecting outward from its outer peripheral wall 9.

Each laminar element 5 will have pairs of substantially straight side edges 11, 12 fixed to corresponding pairs of consecutive support shafts 10 of the plurality, an inner front edge 13 adjacent to the outer peripheral wall 9 of the hub 3 and a free outer front edge 14.

Both the inner front edge 13 and the outer front edge 14 of each sail 6 may be either straight or curved and their possible curvature can be selected depending on the application, possibly varying from sail to sail.

The perimeter extension of the sails 6 will generally be greater than the perimeter distance d between the support shafts 10 of the corresponding pair, preferably with a value between 15% and 50% of this perimeter distance d.

According to a first preferred embodiment, shown in FIG. 2, each support shaft 10 will be associated to contiguous side edges 12, 11′; 12′, 11″; 12″, 11′″; . . . of two distinct and successive laminar elements 5, 5′; 5′, 5″; 5″, 5′″; . . . .

In practice, in this case the contiguous sails 6, 6′, 6″, . . . have always a shaft 10 in common so as to define two impact surfaces of the stream, respectively defined by the set of lower faces 8 and upper faces 7, without continuity solution at least at the connection zones with the support shafts 10.

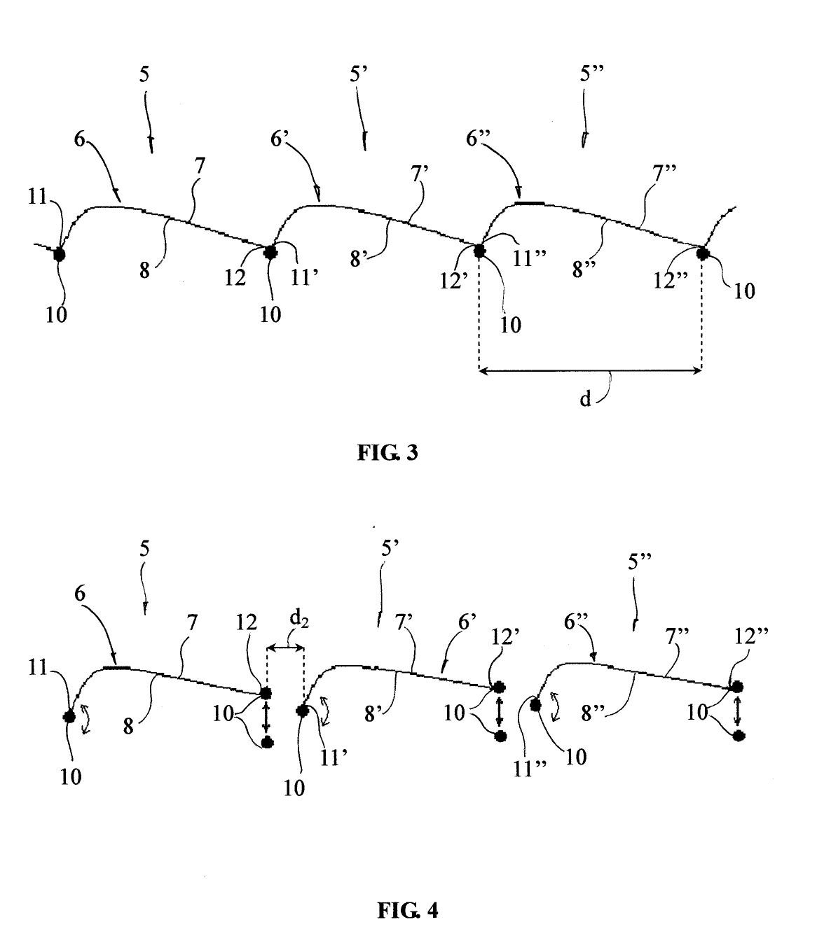

FIG. 3 shows a sequence of three consecutive sails 6, 6′, 6″ belonging to the rotor 2 according to the embodiment disclosed above, in which the sails 6, 6′, 6″ are shown according to a plan development and in which it is possible to observe the absence of spaces between the contiguous side edges 12, 11′; 12′, 11″; 12″, 11′″ of the adjacent sails.

Each support shaft 10 has an inner end 10′ associated with the outer peripheral wall 9 of the hub 3 and a free outer end 10″.

In particular, in a first variant the support shafts 10 may be fixed relative to the hub 3, with the respective inner ends 10′ integral with the outer peripheral wall 9 thereof by any mechanical and/or chemical means, for example by welding, gluing, grafting by interference in suitable seats.

According to an alternative variant, one or more support shafts 10 may be connected to the peripheral wall 9 of the hub 3 in a partial movable manner, for example housed in corresponding substantially radial seats, not shown, made in the peripheral wall 9 of the hub 3, susceptible of rotating about the respective extension axis and/or radially translating in a limited manner in order to allow the different spreading of the sails 6 in function of the application and to the average force of the waves in the place chosen for locating the turbine.

FIG. 4 shows a plan development of three successive sails 6, 6′, 6″ according to a further embodiment of the rotor 2, in which each sail 6, 6′, 6″ is fixed at its side edges 11, 12; 11′, 12′; 11″, 12″ to two support shafts 10 not shared with adjacent sails, so that adjacent laminar elements 5, 5′; 5′, 5″ have respective side edges 12, 11′; 12′, 11″ mutually facing, and in offset relationship with a second predetermined distance d₂ and associated with different support shafts 10.

The same FIG. 4 also shows the support shafts 10 in a condition of partial mobility; in particular the double arrows show the possibility of translation of some support shafts 10.

In this embodiment the two opposing surfaces defined respectively by the lower faces 8 and by the upper faces 7 have perimeter discontinuity, while being designed to be invested by the stream, in an alternating manner, for their whole extension. Irrespective of the presence or absence of perimeter discontinuity between subsequent laminar elements 5, each sail 6 will be made integral with corresponding support shafts 10 by keying and/or firm fixing. Furthermore, the connection portions of the sails 6 to the support shafts 10 may be composed of materials either elastic or non-elastic.

Each sail 6 will be fixed to two support shafts 10 so that it can freely change the spreading direction, correspondingly to the alternation of the flow direction, and so that the sails 6, under the alternate action of the working fluid to which they adapt at each direction reversing, may assume a position alternately concave and convex, in relation to the direction of origin of the fluid.

Thus the starting of the rotation of the rotor 2 will be allowed, which may be suitably directed always in the same direction, as disclosed more clearly hereinafter.

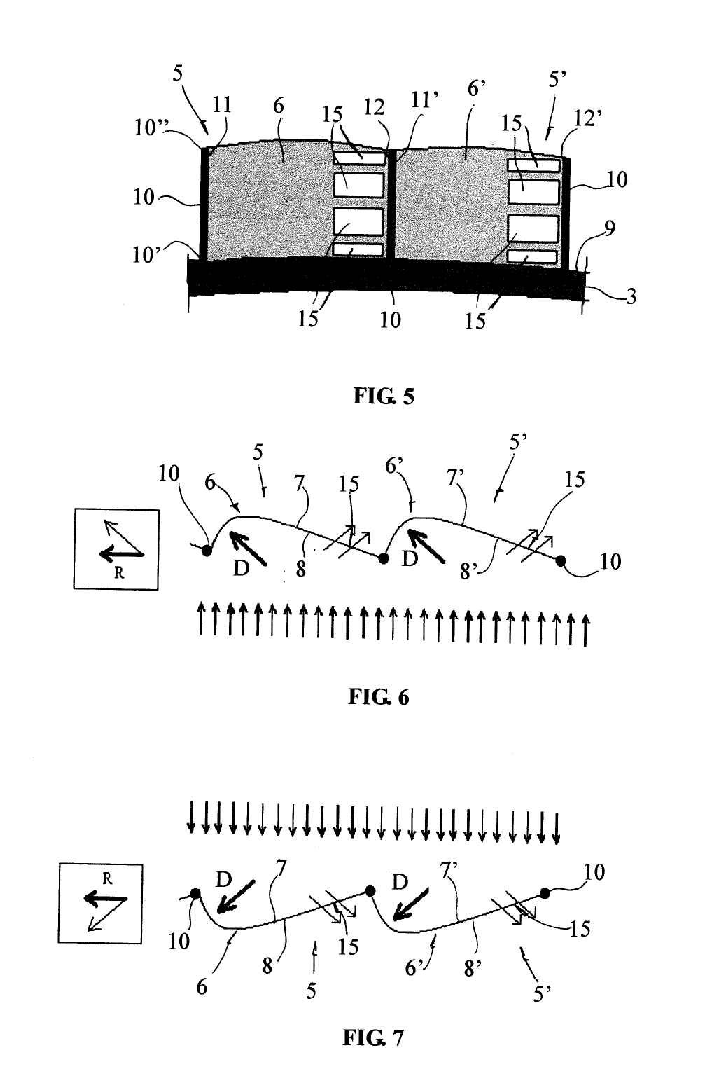

FIG. 5 shows a further particularly advantageous variant of the rotor 2, wherein each laminar element 5 has a corresponding sail 6 provided with one or more openings 15 adapted to allow the partial passage of the fluid stream through the face 7, 8 invested therefrom.

In particular, the openings 15 will be realized on a side portion of the sails 6 and will be arranged thereon in such a position to produce a resulting force R adapted to transmit to the hub 3 a partial driving torque having always the same direction both when the fluid stream acts on one of the faces 7 that when it acts on the other face 8.

Moreover, the laminar elements 5 will be provided with respective openings 15 arranged on corresponding sails 6 in such positions as to produce respective actuating forces D substantially parallel to each other, as shown by FIGS. 6 and 7.

From these figures it could be observed that each sail 6 will vary its instantaneous configuration in response to a force or pressure applied to the sail 6 from the fluid stream, swelling alternately in one sense and in the opposite sense in response to the alternating direction of the fluid stream.

If the turbine structure 1 is inserted in a OWC device, the rotor 2, housed together with the alternator in the containment body provided with the flow conveying conduit, will be carried in rotation due to the action of an air stream moved by the oscillating water column.

In particular, FIG. 6 shows that when the fluid stream, represented by the vertical arrows pointing upwards, impacts on the lower face 8 of the sails 6, it produces on the sails 6 respective driving forces D parallel to each other and which will produce a resultant R, represented by the sum of the tangential components of the single driving forces D, adapted to produce the rotation of the rotor 2 in a predetermined direction.

At the reversal of the flow, shown schematically in FIG. 7, wherein the fluid stream is represented by vertical arrows pointing downward to impact on the upper faces 7 of the sails 6, the driving forces D acting on each sail 6 will always be parallel to each other and adapted to produce a resultant R always directed in the same sense and so to maintain constant the direction sense of rotation of the rotor 2.

The amplitude of the total area of the openings 15 may be selected in function of the specific applications and more specifically in relation to the wave motion of the place selected for locating the turbine.

Preferably, for each laminar element 5, the corresponding openings 15 may have overall extension between 15% and 55% of the extension of the respective sail 6.

The materials used for the various components will depend on the specific applications and environments in which the turbine will be located. In particular if the turbine is placed in the sea both the hub 3 and the laminar elements 5 will be made of suitable materials to ensure high durability even in contact with salt water.

Preferably, the sails 6 will be in a material selected from the group comprising synthetic fibers, composite materials, also elastic and may be possibly formed from fibers having variable stiffness along its extension, for example by means of different thicknesses, to self-regulate its own thrust force in relation to the different degree of elasticity of the materials composing them and to the different density of the same in their parts.

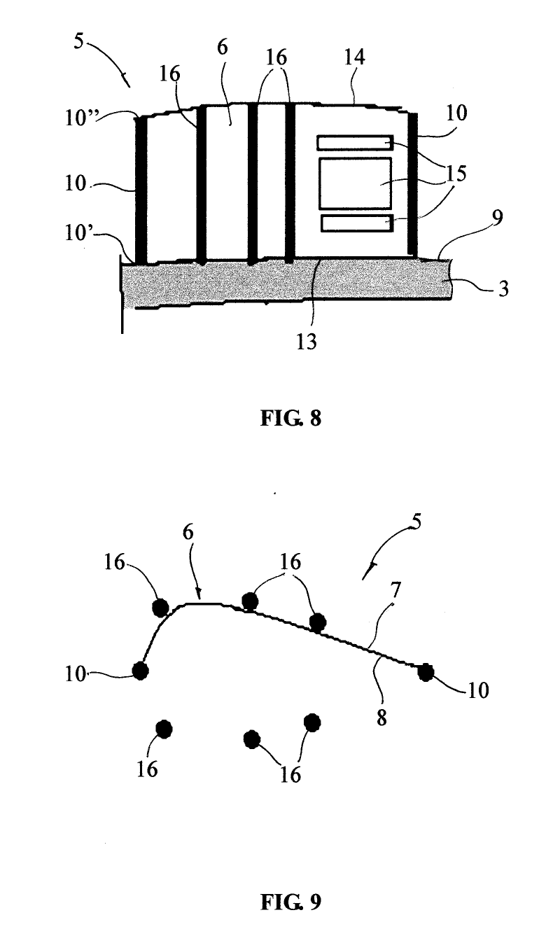

According to a further embodiments, as shown in FIG. 8, each laminar element 5 will comprise one or more substantially radial secondary shafts 16 adapted to limit the spreading of the corresponding sail 6.

Their number, for every single laminar element 5, will preferably be between 2 and 10 and will be selected, as well as their position on the hub 3, in function of the potential speed for the incident fluid.

The secondary shafts 16 will be substantially cylindrical and integral with the peripheral wall 9 of the hub 3, arranged at one or both opposite faces 7, 8 of the sails 6, as schematically shown in FIG. 9.

Their length will be substantially equal to that of the support shafts 10 of the sails 6 and their diameter will be less than that of the shafts 10.

According to a purely indicative embodiment, the rotor 2 of the turbine 1 will comprise a disc-shaped hub 3 mounted on a central axis X directly or indirectly connected to an alternator, which hub 3 consisting of a disc in materials suitable for the sea environment, with diameter and mass variable in function of the power of the plant and of the flywheel effect to be obtained.

On the outer peripheral wall 9 of the hub 3 sixteen support shafts 10 will be keyed by interference to support sixteen sails 6 and whose length will be about 1/7 of the diameter of the hub 3.

The length of the front edges 13, 14 of the sails 6 will be 20% greater than the perimeter distance d between the two successive support shafts 10.

The openings 15 of the sails 6 will have area equal to 45% of the total area of their extension from shaft to shaft, and the sails 6 will be mounted with their respective openings 15 all on the same side.

The assembly of rotor and alternator will be mounted within a tubular container made of steel with a length exceeding of 20% the length of the same assembly, and a diameter 4 mm greater than the outer diameter of the rotor 2 itself.

From above it appears clear that the turbine structure of the invention achieves the intended objects and in particular to provide a OWC device of simple construction and able to self-start even with weak stream, without using rigid elements and complex mechanisms controlling its position and operation, using materials that are highly durable and specifically designed for use in the sea.

The ability of the rotor to rotate always in the same direction of rotation, regardless of the direction of origin of the fluid flow on the sails and without recourse to complex mechanisms makes possible a considerable reduction of construction costs, ease of installation , operation and maintenance, with significant reduction of the related costs. The reduction of the capital required for construction, management and maintenance of similar turbines will also facilitate their diffusion thanks to the more rapid sinking of the investment with respect to the known plants having similar application, where the return on investment is rather limited from the ratio between the capital investment and the efficiency of the system.

The structure and the device according to the invention are susceptible of numerous modifications and variations, all falling within the inventive concept expressed in the appended claims. All the details may be replaced with other technically equivalent elements, and the materials may be different depending on the needs, without departing from the scope of protection of the present invention.

Even if the structure and the device have been disclosed with particular reference to the annexed figures, reference numbers used in the description and in the claims are used to improve the intelligence of the invention and do not constitute any limitation to the claimed scope of protection.

The invention claimed is:

1. A turbine structure, particularly for OWC devices, comprising:
a rotor (2) having a hub (3) rotatable about a central axis of rotation (X) and configured to be operatively coupled to an external system generating electric power;
a plurality of laminar elements (5, 5′, 5″, . . . ) firmly associated with fixedly coupled to said hub (3) and arranged peripherally of said central axis of rotation (X) for intercepting a fluid stream and producing the rotation of said hub (3) in a predetermined direction;
wherein each of said laminar elements (5, 5′, 5″, . . . ) comprises a flexible seal (6, 6′, 6″, . . . ) having both the reciprocally opposite faces (7, 8; 7′, 8′; 7″, 8″; . . . ) adapted to alternatively engage the fluid stream to deform and transmit a driving torque (M) to said rotor (2),
wherein said seals (6, 6′, 6″, . . . ) radially extend outwardly from an outer peripheral wall (9) of said hub (3) with said opposite faces (7, 8; 7′, 8′; 7″, 8″; . . . ) extending, in a non-deformed condition, mainly in planes substantially coplanar with each other, parallel to a rotation plane of said hub (3) and perpendicular to said axis of rotation (X) to define as a whole opposite surfaces adapted to be alternately invested by the fluid stream on their entire extension, and
wherein each of said laminar elements (5, 5′, 5″, . . . ) has a corresponding sail (6) provided with one or more openings (15) configured to allow a partial passage of the fluid stream through the face (7, 8; 7′, 8′; 7″, 8″; . . . ) invested thereby.

2. The turbine structure as claimed in claim 1, characterized wherein said hub (3) of said rotor (2) is substantially disc-shaped or cylindrical and has a plurality of support shafts (10) radially projecting outwardly, each of said laminar elements (5, 5′, 5″, . . . ) having side edges (11, 12; 11′, 12′; 11″, 12″; . . . ) fixed to corresponding consecutive support shafts (10) of said plurality.

3. The turbine structure as claimed in claim 2, wherein said support shafts (10) have inner ends (10′) fixedly connected to said peripheral wall (9) of said disc-shaped or cylindrical hub (3).

4. The turbine structure as claimed in claim 2, wherein said support shafts (10) are housed in substantially radial seats made into said peripheral wall (9) of said disc-shaped or cylindrical hub (3) and are configured to rotate about the respective extension axis or radially translate to a limited degree.

5. The turbine structure as claimed in claim 2, wherein each of said support shafts (10) is associated with contiguous side edges (11, 12; 11′, 12′; 11″, 12″; . . . ) of two distinct and subsequent laminar elements (5, 5′, 5″, . . . ) of said plurality.

6. The turbine structure as claimed in claim 2, wherein adjacent laminar elements (5, 5′, 5″, . . . ) of said plurality have respective side edges (11, 12; 11′, 12′; 11″, 12″; . . . ) reciprocally facing and in offset position at a predetermined distance (d₂), said offset side edges (11, 12; 11′, 12′;
11″, 12″; . . . ) being associated with different shafts (10) of said plurality.

7. (canceled)

8. The turbine structure as claimed in claim 1, wherein, for each of said laminar elements (5, 5′, 5″, . . . ), said one or more openings (15) are made on a side portion of said sails (6, 6′, 6″, . . . ) and arranged thereon in such a position to produce a resultant (R) adapted to transmit to said hub (3) a partial drive torque having always a same sense either when the fluid stream acts on one of said opposite faces (7, 7′, 7″, . . . ) or acts on another of said opposite faces (8, 8′, 8″, . . . ).

9. The turbine structure as claimed in claim 8, wherein the laminar elements (5, 5′, 5″) of said plurality are provided with one or more openings (15) made in said sails (6, 6′, 6″, . . . ) and arranged to produce respective driving forces (D) substantially parallel to each other.

10. The turbine structure as claimed in claim 9, wherein for each of said laminar elements (5, 5′, 5″, . . . ), said one or more openings (15) have a total extension between 15% and 55% of the extension of a corresponding sail (6, 6′, 6″, . . . ).

11. The turbine structure as claimed in claim 10, wherein said sails (6, 6′, 6″, . . . ) have inner and outer front edges (13, 14) substantially straight or curved with a predetermined length.

12. The turbine structure as claimed in claim 11, wherein said predetermined length of one of said outer front edges (14) is greater than a perimeter distance (d) between a support shaft (10) of a corresponding pair with a value between 15% and 50% of said perimeter distance (d).

13. The turbine structure as claimed in claim 1, wherein said sails (6, 6′, 6″, . . . ) are made of a material selected from the group consisting of synthetic fibers, and composite materials, either elastic or not.

14. The turbine structure as claim 1, wherein said hub (3) comprises one or more substantially radial secondary shafts (16) projecting from and integral with said outer peripheral wall (9) and configured to limit a spreading of the corresponding sail (6, 6′, 6″, . . . ).

15. The turbine structure as claimed in claim 14, wherein said hub (3) comprises, at each of said laminar elements (5, 5′, 5″, . . . ), a number of said secondary shafts (16) comprised between 2 and 10, said secondary shafts (16) being substantially cylindrical with a length substantially equal to that of said support shafts (10) and diameter lower than that of said support shafts (10).

16. An OWC device for converting energy from wave motion into electric power, comprising:
a containment body having an inner chamber and a conduit adapted to introduce into said chamber an air column moved by a water column oscillating in function of a wave motion; and
a turbine (1) converting energy associated to the wave motion into electric power, said turbine being housed into said inner chamber and having:
at least one rotor (2) with a hub (3) rotatable about a central axis of rotation (X) and configured to be operatively coupled to an external system generating electric power;
a plurality of laminar elements (5, 5′, 5″, . . . ) fixedly coupled to said hub (3) and arranged peripherally to said central axis (X) to intercept a fluid stream and producing the rotation of said hub (3) in a predetermined direction;
wherein each of said laminar elements (5, 5′, 5″, . . . ) comprises a flexible seal (6, 6′, 6″, . . . ) having opposite faces (7, 8; 7′, 8′; 7″, 8″) adapted to alternately engage the fluid stream to deform and transmit a driving torque (M) to said rotor (2),
wherein said seals (6, 6′, 6″, . . . ) radially extend outwardly from an outer peripheral wall (9) of said hub (3) with the opposite faces (7, 8; 7′, 8′; 7″, 8″; . . . ) extending, in a non-deformed condition, mainly in planes substantially coplanar with each other, parallel to a rotation plane of said hub (3) and perpendicular to said axis of rotation (X) to define as a whole opposite surfaces adapted to be alternately invested by the fluid stream on their entire extension, and
wherein each of said laminar elements (5, 5′, 5″, . . . ) has a corresponding sail (6) provided with one or more openings (15) configured to allow a partial passage of the fluid stream through the face (7, 8; 7′, 8′; 7″, 8″; . . . ) invested thereby.
